(19) United States
(12) Patent Application Publication
(10) Pub. No.: US 2025/0158816 A1
(43) Pub. Date: May 15, 2025

(54) BACKUP AND RECOVERY SYSTEMS AND METHODS FOR CRYPTOWALLETS

(71) Applicant: Thirdwayv, Inc., Irvine, CA (US)

(72) Inventors: Nabil Wasily, Foothill Ranch, CA (US); Michael Atef Ayoub, Irvine, CA (US)

(21) Appl. No.: 18/726,081

(22) PCT Filed: Feb. 1, 2023
(86) PCT No.: PCT/US2023/012140

§ 371 Date: Jul. 1, 2024

Related U.S. Application Data
(60) Provisional application No. 63/305,612, filed on Feb. 1, 2022.

(51) Int. Cl. H04L 9/08; G06Q 20/36; G06Q 20/38; G06Q 20/40; H04L 9/32

(52) U.S. Cl. CPC H04L 9/0894; G06Q 20/36; G06Q 20/3821; G06Q 20/40; H04L 9/085; H04L 9/3226; H04L 2209/56

(57) ABSTRACT

Systems, methods, and devices for backup and recovery of crypto wallets. A crypto wallet may interoperate with multiple removable authentication devices which may operate in concert to restore access to the crypto wallet in the event that a PIN and/or a seed value of the crypto wallet is lost or forgotten. By implementing multiple removable authentication devices, two-person (or greater) integrity (TPI) is implemented to ameliorate theft risk by requiring multiple devices to be operated in concert by different users who know the different PINs of the different removable authentication devices in order to recover access to the crypto wallet.

### CROSS-REFERENCE TO RELATED APPLICATIONS

This application is based upon and claims priority to U.S. provisional patent application No. 63/305,612 entitled “BACKUP AND RECOVERY SYSTEMS AND METHODS FOR CRYPTOWALLETS,” filed Feb. 1, 2022, the entire content of which is incorporated herein by reference.

### BACKGROUND

### 1. Field

The present disclosure is directed to crypto wallets, and more specifically, the present disclosure is directed to backup and recovery of crypto wallets.

### 2. Description of the Related Art

Crypto wallets are used to generate and store the cryptographic keys required for performing cryptocurrency transactions. The private keys of a crypto wallet are usually generated via a deterministic hierarchical scheme based on one master secret, called the seed value. If the hardware wallet is damaged, lost, stolen, or if the owner of the wallet forgets the password or PIN code that secures access to the wallet, the owner can recover the wallet if he/she knows the seed value. However, if the owner does not know, or forgets, the seed value, then the wallet is typically unrecoverable. Moreover, if the owner is incapacitated or dies, the wallet is typically unrecoverable. Thus, there is a need for other ways to recover a crypto wallet.

### SUMMARY

Systems, apparatuses, and/or methods for backup and recovery for crypto wallets are provided. In various embodiments, a method of recovering electronic access to a cryptocurrency wallet on a hardware wallet device may include various aspects. For instance, the method may include connecting, the hardware wallet device, to a physically attached removable authentication device in electronic communication with the hardware wallet device. The method may include receiving, by a user input component of the hardware wallet device, a personal identification number (PIN) sequence. The method may include comparing, by the removable authentication device, the PIN sequence to a stored PIN stored on the removable authentication device. The method may include retrieving, by the hardware wallet device, in response to the stored PIN and the PIN sequence matching, a secret share from the removable authentication device and storing the secret share on the hardware wallet device. The method may include determining if a number of stored secret shares on the hardware wallet device meets or exceeds a first threshold. In response to the number of stored secret shares on the hardware wallet device meeting or exceeding the first threshold, the method may include applying a first secrets sharing technique to the stored secret shares on the hardware wallet device to recover a seed value of the hardware wallet device and storing the recovered seed value on the hardware wallet device. In response to the number of stored secret shares on the hardware wallet device not meeting and not exceeding the first threshold, the method may include displaying a message on a user output component of the hardware wallet device instructing a user to physically attach one or more additional removable authentication device to the hardware wallet device in electronic communication with the hardware wallet device.

The method may include one or more further aspects. For example, following the displaying of the message on the user output component of the authentication device or the hardware wallet device, the method may further includes connecting, the hardware wallet device to the one or more additional removable authentication device in electronic communication with the hardware wallet device.

In various embodiments, the one or more additional removable authentication devices are connected sequentially or in series. In various embodiments, the one or more additional removable authentication devices are connected in parallel. In various embodiments, the stored PIN stored on the removable authentication device is not revealed to the hardware wallet device. In various embodiments, the stored PIN stored on the removable authentication device is not revealed to the hardware wallet device nor to any other device.

The method may have further aspects. For instance, the method may include receiving, by the user input component of the hardware wallet device a further personal identification number (PIN) sequence. The method may include comparing, by the one or more additional removable authentication device, the further PIN sequence to a further stored PIN on the one or more additional removable authentication devices. The method may include retrieving, by the hardware wallet device, in response to the further stored PIN matching the further pin sequence, a further secret share from the removable authentication device and storing the further secret share on the hardware wallet device. The method may include determining that the number of stored secret shares on the hardware wallet device meets or exceeds the first threshold. In response to the number of stored secret shares on the hardware wallet device meeting or exceeding the first threshold, the method may include applying the first secrets sharing technique to the stored secret shares on the hardware wallet device to recover the seed value of the hardware wallet device and storing the recovered seed value on the hardware wallet device. In an aspect, the first secrets sharing technique may be Shamir's secret sharing method.

The method may have further aspects. The method may include notifying, by the hardware wallet device, a trusted server of a seed value restoration attempt. The method may include transmitting, by the trusted server, a rejection message to a user electronic messaging platform. The method may include receiving, by the trusted server, a denial message from the user electronic messaging platform. The method may include providing, by the trusted server, the denial message to the hardware wallet device. The method may include interrupting, by the hardware wallet device, the method and denying recovery of the seed value in response to the receiving the denial message.

A method of establishing electronic access recovery credentials for a cryptocurrency wallet on a hardware wallet device is provided. The method may include setting, on the hardware wallet device, a first number, N, of secret shares to be generated based on a seed value. The method may include setting, on the hardware wallet device, a second number, M, less than or equal to N, of secret shares required to recover a seed value. The method may include applying, by the hardware wallet device, a first secret sharing technique to generate the first number, N, of the secret shares from the seed value. The method may include communicating, by the hardware wallet device, with an attached removable authentication device. The method may include receiving, from a user input component of the hardware wallet device, a pin sequence. The method may include setting, by the hardware wallet device, a PIN stored on the removable authentication device to be the pin sequence. The method may include storing, by the hardware wallet device, a first secret share of the first number, N, of secret shares of the hardware wallet device on the remote authentication device having the pin sequence. The method may include displaying a message on a user output component of the hardware wallet device instructing a user to physically attach one or more additional removable authentication device to the hardware wallet device in electronic communication with the hardware wallet device.

The method may include one or more further aspect. For instance, following the displaying the message on the user output component of the authentication device, the method may include connecting, the hardware wallet device to the one or more additional removable authentication device in electronic communication with the hardware wallet device. In various embodiments, the one or more additional removable authentication devices are connected sequentially or in series. In various embodiments, the one or more additional removable authentication devices are connected in parallel.

The method may also include communicating, by the hardware wallet device, with a further attached removable authentication device of the one or more additional removable authentication devices. The method may also include receiving, from the user input component of the hardware wallet device, a further pin sequence. The method may also include setting, by the hardware wallet device, a further PIN stored on the further removable authentication device to be the further pin sequence. The method may also include storing, by the hardware wallet device, a further secret share of the first number, N, of secret shares of the hardware wallet device on the further remote authentication device having the further pin sequence. The first secret sharing technique may be Shamir's secret sharing method.

A hardware wallet device to provide an electronically accessible cryptocurrency wallet is disclosed. The device may include a user input component configured to receive a personal identification number (PIN) sequence from a user. The device may include a removable authentication device reader configured to physically attach to a physically attachable removable authentication device containing a stored PIN and connect the removable authentication device in electrical communication to a processor. The device may include the processor, wherein the processor is configured to communicate with the removable authentication device to cause the removable authentication device to compare the PIN sequence to the stored PIN, wherein the processor is further configured to retrieve a secret share from the removable authentication device in response to the PIN sequence matching the stored PIN. The device may include a digital storage unit configured to store the secret share retrieved from the removable authentication device. The processor may be further configured to determine if a number of stored secret shares on the hardware wallet device meets or exceeds a first threshold. In response to the number of stored secret shares on the digital storage unit of the hardware wallet device meeting or exceeding the first threshold, the processor may apply a first secrets sharing technique to the stored secret shares on the digital storage unit to recover a seed value of the hardware wallet device and store the recovered seed value on the digital storage unit. In response to the number of stored secret shares on the digital storage unit not meeting and not exceeding the first threshold, the processor may display a message on a user output component of the hardware wallet device instructing a user to physically attach one or more additional removable authentication device to the hardware wallet device and in electronic communication with the hardware wallet device.

The hardware wallet device may have additional or other aspects. For instance, following the displaying the message on the user output component of the authentication device, the one or more additional removable authentication device connects in electronic communication with the hardware wallet device. The one or more additional removable authentication devices may be connected sequentially or in series. The one or more additional removable authentication devices may be connected in parallel.

The user input component may be configured to receive a further personal identification number (PIN) sequence. The processor may be configured to communicate with the one or more additional removable devices to cause the one or more additional removable devices to compare the further PIN sequence to a further stored PIN on the one or more additional removable authentication devices. The processor may be configured to retrieve in response to the further stored PIN matching the further pin sequence, a further secret share from the removable authentication device and store the further secret share on the digital storage unit of the hardware wallet device. The processor may determine that the number of stored secret shares on the digital storage unit of the hardware wallet device meets or exceeds the first threshold, and the processor may apply, in response to the number of stored secret shares on the hardware wallet device meeting or exceeding the first threshold, the first secrets sharing technique to the stored secret shares on the digital storage unit to recover the seed value of the hardware wallet device and stores the recovered seed value on the digital storage unit. In various embodiments, the first secrets sharing technique comprises Shamir's secret sharing method.

In various embodiments, the hardware wallet device further includes a communication device connected to the processor, wherein the communication device is configured to notify a trusted server of a seed value restoration attempt. The trusted server may be configured to transmit a rejection message to a user electronic messaging platform. The trusted server may be configured to receive a denial message from the user electronic messaging platform. The trusted server may be configured to provide the denial message to the hardware wallet device. The processor of the hardware wallet device may be configured to deny recovery of the seed value in response to the receiving the denial message.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A depicts a block diagram of a crypto wallet backup and recovery system, in accordance with various aspects;

FIG. 1B illustrates an example implementation of the system of FIG. 1A, in accordance with various aspects;

FIG. 2 shows a method of generating a recovery seed phrase, in accordance with various aspects;

FIG. 3 shows a method of recovering a crypto wallet using a recovery seed phrase, in accordance with various aspects;

FIG. 4 shows a method of backing up a seed value, in accordance with various aspects;

FIG. 5 shows a method of recovering a crypto wallet using a seed value, in accordance with various aspects;

FIG. 6 shows a method of establishing electronic access recovery credentials for a cryptocurrency wallet on a hardware wallet device, in accordance with various aspects;

FIG. 7 shows a method of recovering electronic access to a cryptocurrency wallet on a hardware wallet device, in accordance with various aspects;

FIG. 8 shows a method of interrupting recovery of a crypto wallet, in accordance with various aspects;

FIG. 9 shows a method of payload signature and verification by a crypto wallet, in accordance with various aspects; and

FIG. 10 shows a method of transaction signature and approval by a crypto wallet, in accordance with various aspects.

### DETAILED DESCRIPTION

As disclosed herein, systems, apparatuses, and methods for backup and recovery of cryptocurrency wallets (“crypto wallets”) are provided.

Crypto wallets are used to generate and store cryptographic keys required for performing cryptocurrency transactions. Crypto wallets include at least two common varieties. Software wallets are crypto wallets that are a smartphone or desktop application that stores the cryptographic keys and also manages incoming and outgoing transactions. Hardware wallets are crypto wallets that have an embedded device that stores the private keys used for signing outgoing transactions. The hardware wallet communicates with a smartphone, desktop, or web application “watch-only wallet” that only stores the corresponding public keys of the hardware wallet's private keys. A watch-only wallet monitors incoming transactions and prepares unsigned outgoing transactions for the embedded device but cannot sign outgoing transactions. The embedded device verifies the transaction details, retrieves the applicable signing key, signs the transaction, and sends the signed transaction back to the smartphone, desktop, or web application to be broadcast to mining nodes.

Hardware crypto wallets are known to be more secure than software crypto wallets because the software crypto wallets coexist with other applications on a smartphone or desktop and thus the private keys are susceptible to software attacks on the shared platform, while the keys in a hardware crypto wallet never leave the embedded device. Access to hardware crypto wallet operations is often protected by a personal identification number (PIN).

Private keys of a crypto wallet may be generated via a deterministic hierarchical scheme based on one master secret. The master secret is called the seed value. For this purpose, an algorithm may convert the seed value into a sequence or words, known as the recovery seed phrase, that the wallet owner may write down on paper and store in a safe place. However, the recovery seed phrase itself is subject to loss or theft. Moreover, lack of succession planning is a significant risk for hardware wallets. For instance, if a wallet owner dies or become incapacitated without informing others of the hardware wallet PIN or of the recovery seed phrase, the cryptocurrency associated with the hardware wallet may be lost.

The systems, apparatuses, and methods provided herein address these and other concerns. The systems, apparatuses, and methods provide for different backup mechanisms, including mechanisms that use smart cards (secure elements). A smart card is a microprocessor equipped token to store and/or process confidential material for the benefit of a larger device. A secure element is a tamper-resistant platform capable of securely hosting applications and their confidential and cryptograph data (e.g., key management) and may be a type of smart card.

In some instances, backup information capable to access a crypto wallet may be stored via a smart card for the wallet owner, with the seed value stored on it and protected by a PIN that the owner sets when the backup is prepared. In other instances, backup information capable to access a crypto wallet may be stored via a group of smart cards that the wallet owner can hand over to trustees, with a share of the seed value stored on each and protected by a PIN that is set when the backup is prepared. The shares are generated in such a way that the seed value can be restored if a certain minimum number of shares are present, while individual shares and subsets of shares less than the minimum number for seed value reconstruction do not provide any information about the seed value. For instance, Shamir's Secret Sharing (SSS) may be implemented. In SSS, any T out of N shares may be used to recover the secret. The system relies on the principle that a unique polynomial of degree T-1 can be fit to any set of T points that lie on that polynomial. That is, it takes T points to define a polynomial of degree T-1. Thus, by creating a polynomial of degree T-1, with the secret as the first coefficient and the remaining coefficients picked at random, then by finding N points on the curve and giving one to each trustee, backup information may be distributed in individual shares. When at least T out of the N shares are revealed, there is sufficient information to fit a (T-1)^{th} degree polynomial to them, the first coefficient being the secret.

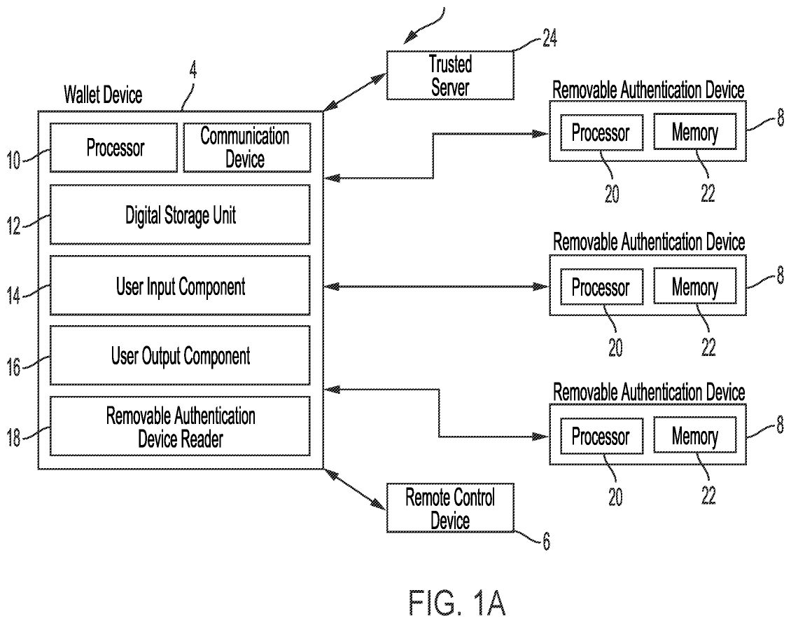

An example system for backup and recovery of a crypto wallet may have different devices that work in concert to perform these mechanisms. Directing attention now to a combination of FIG. 1A and FIG. 1B, a system 2 for backup and recovery of a crypto wallet may include one or more wallet device 4. A wallet device 4 may be a hardware crypto wallet embedded device. For instance, the wallet device 4 may have processing, communication, and memory capabilities. The system 2 may include a remote control device 6. The remote control device 6 may be a device able to control cryptocurrency transactions in concert with the wallet device 4, but without access to the private keys securely stored within the wallet device 4. The system 2 may also include one or more removable authentication device 8. A removable authentication device 8 may be removable connectable to and disconnectable from the wallet device 4. For instance, the removable authentication device 8 may include a smart card that can be inserted into the wallet device 4 and may communicate electronically with the wallet device 4. Removable authentication devices 8 may include seed values or may include shares that may be combined with shares on other removable authentication devices 8 to reveal seed values.

The discussion will now consider wallet devices 4, remote control devices 6, and removable authentication devices 8 in greater detail. In various embodiments, a wallet device 4 may include a processor 10. The processor 10 may be a computer processor, a microprocessor, or any other electronic device configured to perform calculations. The wallet device 4 may include a digital storage unit 12. The digital storage unit 12 may include an electronic memory. The memory may interoperate with the processor 10 to store data for future use and to retrieve data for present use. In various instances, the digital storage unit 12 may include securely stored private keys, or may include one or more seed value, one or more PIN, and/or one or more shares that upon combination interoperate to reveal one or more seed values. The wallet device 4 may include a user input component 14. The user input component 14 may include one or more keyboard, pushbutton, touch sensitive element such as a touch screen, audio device, haptic device, and/or other human-machine interface capable of receiving input from a human. The wallet device 4 may include one or more user output component 16. The user output component 16 may include one or more visual display screen, light indicator, audio device, haptic device, and/or other human-machine interface capable of providing output to a human. The wallet device 4 may include one or more removable authentication device reader 18. The removable authentication device reader 18 may include an electronic hardware module having connections connectable to a removable authentication device 8 to interconnect the removable authentication device 8 with the processor 10 for data exchange. The removable authentication device reader 18 may include a smart card slot that a removable authentication device 8 having a smart card may be physically inserted into. The wallet device 4 may have a communication device 21 configured to communicate with other devices such as a remote control device 6, or a network, or a trusted server 24 via a network.

As specifically illustrated in FIG. 1B, the wallet device 4 may have a user input component 14 that includes a plurality of pushbuttons and a user output component 16 that includes an LCD or other visual screen display. The removable authentication device reader 18 may be a smart card slot and reader to receive a removable authentication device 8 including an insertable smart card.

With ongoing reference to FIGS. 1A-B, the remote control device 6 may include an application running on a smartphone 7. In further instances, the remote control device 6 is a single-purpose device configured to initiate cryptocurrency transactions. Cryptocurrency transactions initiated by a remote control device may be allowed or disallowed by the wallet device 4 that securely holds the associated private key(s). Thus, the remote control device 6 may be configured to communicate with the wallet device 4, and specifically, the communication device 21 of the wallet device 4.

The removable authentication device 8 may, as mentioned, include a smart card. The removable authentication device 8 may include a processor 20 configured to perform cryptographic or other operations and a memory 22 configured to store data. In various embodiments, the memory 22 may store a seed value. The memory 22 may store a share of a seed value according to a Shamir's Secret Sharing technique. The memory 22 may also store a personal identification number (PIN) associated with unlocking or revealing the seed value or the share. The processor 20 of the removable authentication device 8 may determine whether a provided PIN number (such as a PIN entered by a user of a wallet device 4 into a user input component 14) matches or fails to match a stored PIN in the memory 22. The processor 20 may perform this operation without revealing the correct PIN to any device outside of the removable authentication device 8. In this manner, the correct PIN stored in the memory 22 may be protected from discovery or efforts to compromise or defeat the PIN. In an aspect, a PIN associated with a smart card (removable authentication device 8) is verified by the card itself, not the hardware wallet. In various aspects, the removable authentication device 8 does not allow access to or reveal the PIN associated with the removable authentication device 8 to anyone.

Finally, the system 2 may also include a trusted server 24. The trusted server 24 may be operatively connectable to the wallet device 4. The trusted server 24 may communicate with the wallet device 4 in connection with cryptocurrency transactions. Aspects of communication with the trusted server 24 are disclosed herein.

Having introduced the system 2 and details of components of the system 2, an example architecture of the system 2 with some or all of the components is now provided. Briefly, a system 2 may include a hardware crypto wallet embedded device (wallet device 4). The device may have one or more processor 10, one or more digital storage unit 12, one or more user input component 14 such as buttons, one or more user output component 16 such as a display, and/or one or more removable authentication device reader 18, such as a physical interface (e.g., slot) for a smart card. The system 2 may include a plurality of removable authentication devices 8 (e.g., smart cards), each having a processor 20 and a memory 22 providing secure storage. A remote control device 6, such as a smartphone, a desktop application, or a web application may communicate with the embedded device over a wireless communication protocol (for example, Bluetooth Low Energy (BLE)) or a cable-based communication protocol (for example, Universal Serial Bus (USB)). The wallet device 4 may have a communication device 21 capable of communicating over the wireless communication protocol.

The wallet device 4 may have various functionalities. For instance, the wallet device 4 may require a user to set up a PIN, allow the user to enter the PIN via the one or more buttons or touch keys, and may securely store the PIN. The wallet device 4 may require the user to reenter the PIN via the one or more buttons or touch keys to unlock the device before each use, wherein a successful PIN entry unlocks the device for a certain duration. The wallet device 4 may erase all keys and reset the wallet device 4 if the PIN is entered incorrectly a certain successive number of times. In various embodiments, the PIN is stored in a removable authentication device 8 attached to the wallet device 4 so that the correct PIN is not revealed to the wallet device 4, but rather the wallet device 4 receives an inputted PIN and provides the inputted PIN to the removable authentication device 8 which then compares it to a securely stored PIN.

In various embodiments, the wallet device 4 stores the wallet's seed value. The seed value may be obtained by different methods. For instance, if a new wallet is generated, then the wallet device 4 may randomly generate the seed value. In this case, the wallet device 4 also allows the wallet owner to prepare one or more backup options as described below. In other instances, the seed value of an existing wallet is recovered by one of the backup options below.

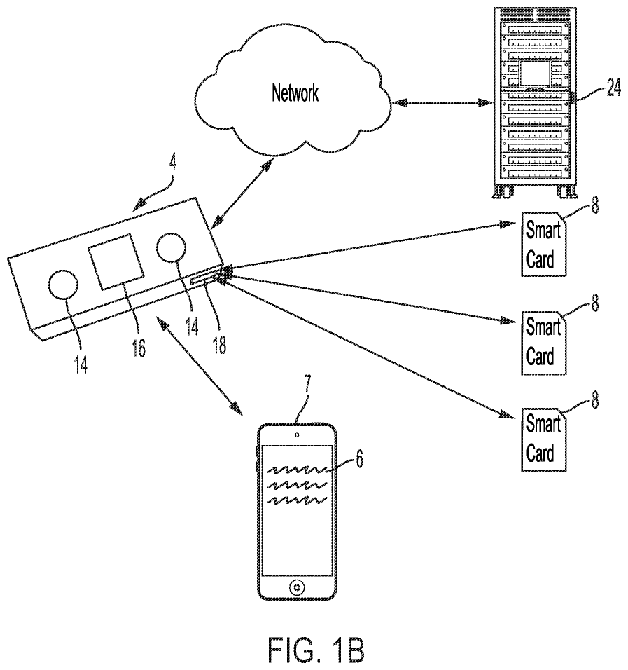

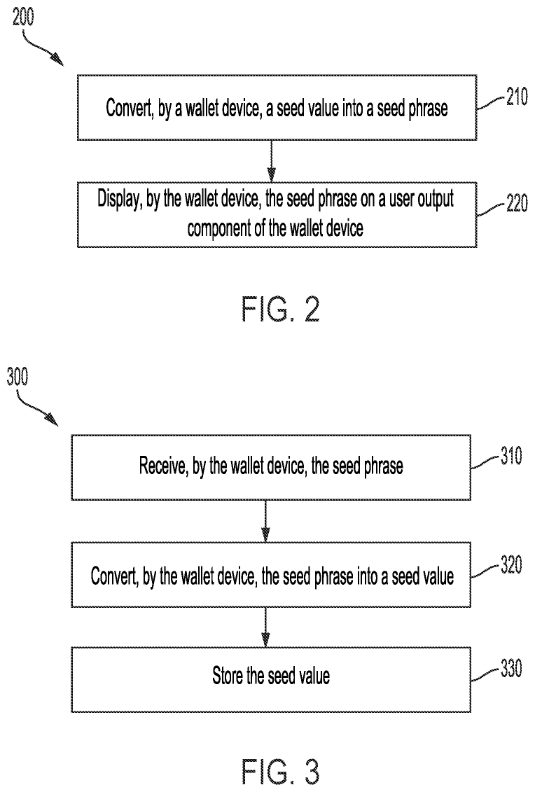

In various instances, a backup option may involve use of a recovery seed phrase. With combined reference to FIGS. 1A-B and FIG. 2, in an example implementation, a method 200 of generating a recovery seed phrase may proceed as follows. To create a backup, the processor 10 of the wallet device 4 may convert a seed value into a seed phrase (block 210). The wallet device 4 may display the sequence of letters or words of the seed phrase on the user output component 16 of wallet device 4 (block 220). With reference to FIGS. 1A-B and FIG. 3, a method 300 of recovering a crypto wallet using a recovery seed phrase is provided. The wallet device 4 may receive a sequence of letters or words of the seed phrase from the user via the user input component 14 (block 310). The wallet device 4 may convert the seed phrase into a seed value (block 320). The recovered seed value is then securely stored in the digital storage unit 12 of the wallet device 4 (block 330).

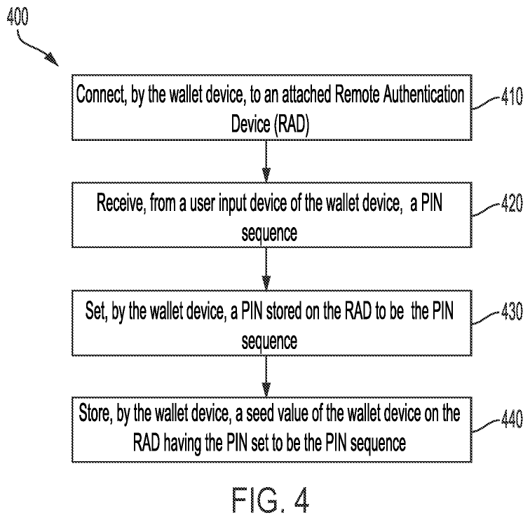

With combined reference to FIGS. 1A-B and FIG. 4, in an example implementation, a method 400 of backing up a seed value is provided. The method may include communicating by the wallet device 4 with an attached removable authentication device 8 (block 410) via the removable authentication device reader 18 of the wallet device 4. Such communication may be via a contact or contactless interface such as ISO-7816, USB, I2C, NFC, etc. The method may include receiving from a user input component 14 of the wallet device 4, a PIN sequence (block 420). The method may include setting, by the wallet device 4, a PIN stored on the removable authentication device 8 to be the PIN sequence (block 430). The method may include storing, by the wallet device 4, a seed value of the wallet device 4 on the removable authentication device 8 having the PIN set to be the PIN sequence (block 440).

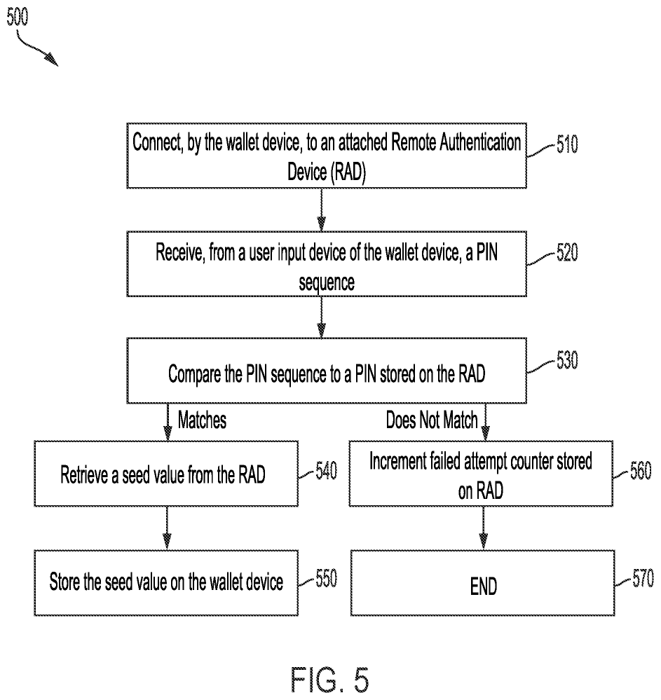

With combined reference to FIGS. 1A-B and FIG. 5, in an example implementation, a method 500 of recovering a crypto wallet using a seed value may include connecting, by the wallet device 4, with an attached removable authentication device 8 (block 510). The method 500 may include receiving from a user input component 14 of the wallet device 4, a PIN sequence (block 520). The method may include comparing the PIN sequence to a PIN stored on the removable authentication device 8 (block 530). In response to the PIN sequence not matching the PIN, the removable authentication device 8 may increment a failed attempt counter stored on the removable authentication device 8 (block 560) and the method ends (block 570). After a certain pre-set number of failed attempts, the removable authentication device 8 may erase the data thereon and reset. In response to the PIN sequence matching the PIN, the wallet device 4 may retrieve a seed value from the removable authentication device 8 (block 540). The wallet device 4 may store the seed value on the wallet device 4 (block 550).

In further instances, a method of backing up a seed value in shares on multiple removable authentication devices acting in cooperation, as well as a method of recovering a seed value via shares on multiple removable authentication devices are both provided. However, before detailing these methods in reference to figures, a brief summary may be helpful.

In various instances, the wallet device 4 has the following parameters with default values that the user may change: (1) a total number of secret shares N (greater than one, and less than or equal to the number of available smart cards) to be generated based on the seed value; and (2) a minimum number or threshold of secret shares M (greater than one, and less than or equal to the total number of shares) that are required to be present to recover the seed value.

To create a backup of a seed value, the wallet device 4 applies a secret sharing method, for example Shamir's secret sharing method, to calculate the values of each of the secret shares based on the seed value, such that: (1) the knowledge of the values of any number of shares, where the number of shares is less than the specified threshold M, does not reveal any information about the seed value, and (2) the knowledge of the values of any number of shares, where the number of shares is equal to or greater than the specified threshold M, is sufficient to restore the seed value.

After calculating the values of the shares, the wallet device 4 may communicate with a first removable authentication device 8 over the removable authentication device reader 18. The wallet device 4 takes a first PIN for the removable authentication device 8 from the user via the user input component 14 and sets up the first PIN on the first removable authentication device 8. The wallet device 4 stores the first secret share on the first removable authentication device 8. The process is repeated for writing the second secret share and the second PIN on the second removable authentication device 8 and so on until each secret share is written on a different removable authentication device 8.

To protect the backup, each removable authentication device 8: (1) securely stores the PIN and the secret, (2) requires PIN reentry to release the secret, and (3) erases the secret and resets the removable authentication device 8 if the PIN is incorrectly entered a certain successive number of times.

To recover a seed value from shares on multiple removable authentication devices 8, the wallet device 4 may communicate with a first removable authentication device 8 over the removable authentication device reader 18. The wallet device 4 may take the first PIN for the first removable authentication device 8 from the user via the user input component 14 of the wallet device 4. The wallet device 4 may write the first PIN to the first removable authentication device 8. The wallet device 4 may retrieve the first secret share from the first removable authentication device 8 if the PIN is correct. The wallet device 4 may temporarily store the first secret share.

The process is repeated for retrieving the second secret share from the second removable authentication device 8 and so on until the number of distinct secret shares matches the threshold for successful seed value reconstruction.

The system should ensure that the owner of the wallet should be notified by the wallet by sending e-mails, messages, app notifications, etc., from the wallet to a trusted server 24, which forwards to wallet owner accounts included in a wallet certificate. The trusted server 24 ensures that the wallet owner does not stop the succession process by responding to any of these notifications for a certain period of time (such as 1 or 2 months), after which the trusted server 24 responds to the wallet with a signed message to approve the succession process. The wallet verifies the trusted server 24 signature against a previously stored server public key before proceeding with the succession process. The wallet owner sets up the period of the succession delay upon setting up the wallet. When the wallet device 4 retrieves a number of distinct secret shares that matches the threshold of successful reconstruction, it applies the corresponding secret recovery method to restore the seed value. The wallet device 4 then securely stores the recovered seed value.

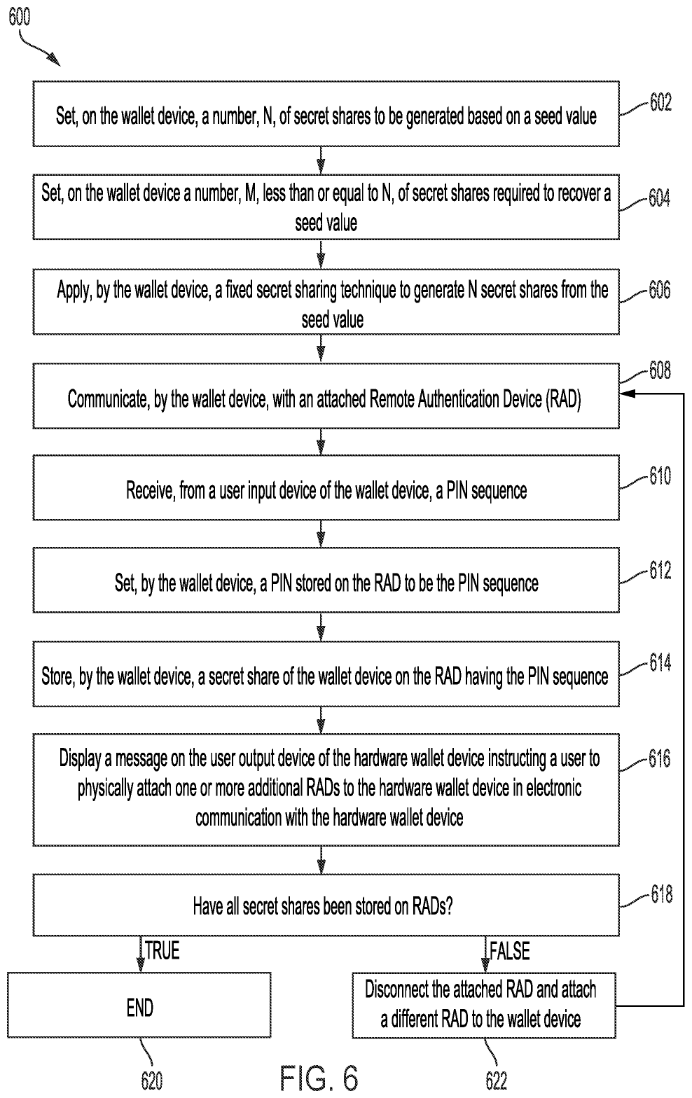

Having introduced the concept of creating a backup of a seed value and the concept of recovering a seed value from shares on multiple removable authentication devices 8, attention is directed to various figures for a more detailed discussion of examples. With combined reference to FIGS. 1A-B and FIG. 6, in an example implementation, a method 600 of establishing electronic access recovery credentials for a cryptocurrency wallet on a hardware wallet device is provided. The method may include setting, on the hardware wallet device 4, a first number, N, of secret shares to be generated based on a seed value (block 602). The method may include setting, on the hardware wallet device 4, a second number, M, less than or equal to N, of secret shares required to recover a seed value (block 604). The method may include applying, by the hardware wallet device 4, a first secret sharing technique to generate the first number, N, of the secret shares from the seed value (block 606). The method may include communicating, by the hardware wallet device 4, with an attached removable authentication device 8 (block 608). The method may include receiving from a user input component 14 of the hardware wallet device 4, a PIN sequence (block 610). The method may include setting, by the hardware wallet device 4, a PIN stored on the removable authentication device 8 to be the PIN sequence (block 612). The method may include storing, by the hardware wallet device 4, a first secret share of the first number, N, of secret shares of the hardware wallet device 4 on the removable authentication device 8 having the PIN sequence (block 614). The method may include displaying a message on a user output component 16 of the hardware wallet device 4 instructing a user to physically attach one or more additional removable authentication device 8 to the hardware wallet device 4 in electronic communication with the hardware wallet device 4 (block 616). The hardware wallet device 4 may determine whether all secret shares have been stored on removable authentication devices 8 (block 618). In response to this query being TRUE, the method ends (block 620); otherwise, the method proceeds with disconnecting the attached removable authentication device 8 and attaching a different removable authentication device 8 to the wallet device 4 (block 622). The method returns to block 608.

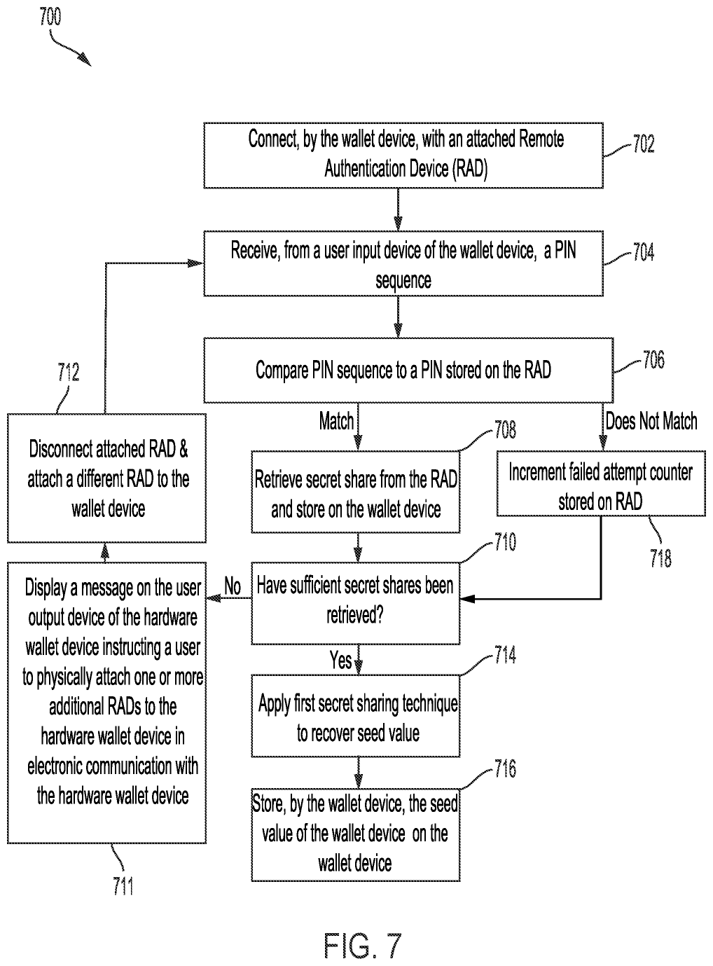

With combined reference to FIGS. 1A-B and FIG. 7, in an example implementation, a method 700 of recovering electronic access to a cryptocurrency wallet on a hardware wallet device 4 is provided. The method may include connecting, the hardware wallet device 4, to a physically attached removable authentication device 8 in electronic communication with the hardware wallet device 4 (block 702). The method may include receiving, by a user input component 14 of the hardware wallet device 4, a PIN sequence (block 704). The method may include comparing, by the processor 10 of the hardware wallet device 4 and/or the processor 20 of the removable authentication device 8, the PIN sequence to a stored PIN stored on the removable authentication device 8 (block 706). The method may include retrieving, by the hardware wallet device 4, in response to the stored PIN and the PIN sequence matching, a secret share from the removable authentication device 8 and storing the secret share on the digital storage unit 12 of the hardware wallet device 4 (block 708). The method further includes determining if a number of stored secret shares on the hardware wallet device 4 meets or exceeds a first threshold (block 710). Moreover, if the PIN sequence and stored PIN do not match in block 706, the method skips block 708 and proceeds directly to block 710. In response to the number of stored secret shares on the hardware wallet device 4 meeting or exceeding the first threshold, the processor 10 of the wallet device 4 applies a first secrets sharing technique to the stored secret shares on the hardware wallet device 4 to recover a seed value of the hardware wallet device 4 and stores, by the hardware wallet device 4, the recovered seed value of the hardware wallet device 4 on the digital storage unit 12 of the hardware wallet device 4 (block 714). In response to the number of stored secret shares on the hardware wallet device 4 not meeting and not exceeding the first threshold (block 710), the user output component 16 of the hardware wallet device 4 displays a message instructing a user to physically attach one or more additional removable authentication device 8 to the hardware wallet device 4 in electronic communication with the hardware wallet device 4 (block 711). The attached removable authentication device 8 is then disconnected and a different removable authentication device 8 is attached to the wallet device 4 (block 712) and the method returns to block 704.

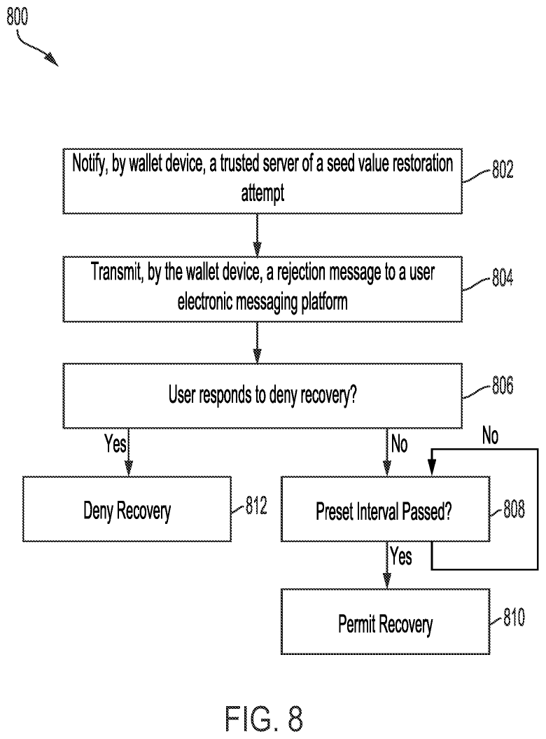

With reference to FIGS. 1A-B and FIG. 8, a method 800 of interrupting recovery of a crypto wallet may allow a user to prevent collusion among holders of shares to recover the wallet (e.g., gain access to the wallet), against the wishes of the user. For instance, the method may include notifying, by the wallet device 4, a trusted server 24 of a seed value restoration attempt according to the prior methods, and particularly, method 700 of FIG. 7 (block 802). The wallet device 4 may transmit a rejection message to a trusted server 24 which may utilize a user electronic messaging platform, such as e-mail, messages, app notifications, etc., to communicate with a user (block 804). In response to the user responding to deny recovery (block 806), recovery is denied (block 812). In response to the user not responding to deny recovery, the method includes awaiting the passage of a preset interval of time (block 808), after which the wallet device 4 and the trusted server 24 communicate to permit recovery of the credentials.

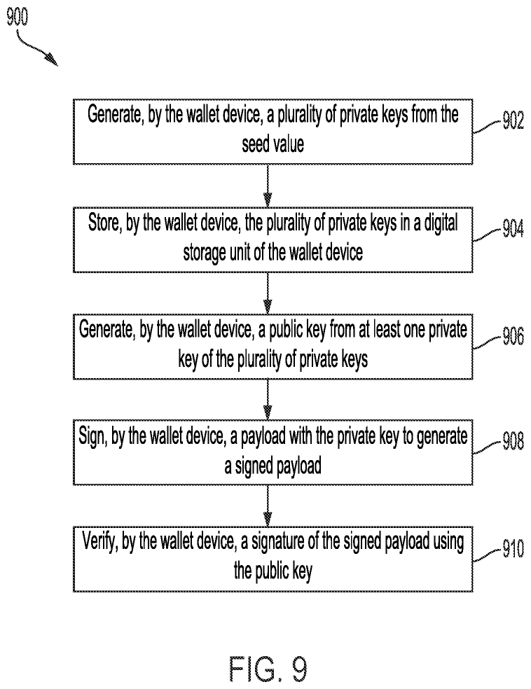

Finally, the hardware wallet device 4 may perform various cryptocurrency operations briefly introduced in preceding paragraphs. For instance, with reference to FIGS. 1A-B and FIG. 9, a method 900 of payload signature and verification by a crypto wallet may include generating, by the wallet device 4, a plurality of private keys from a seed value (block 902). The method may include storing, by the hardware wallet device 4, the plurality of private keys in a digital storage unit 12 of the hardware wallet device 4 (block 904). The method may include generating, by the hardware wallet device 4, a public key from at least one private key of the plurality of private keys (block 906). The method may include signing, by the hardware wallet device 4, a payload, such as a non-fungible token, with the private key to generate a signed payload (block 908). Finally, the method may include verifying, by the hardware wallet device 4, a signature of the signed payload using the public key (block 910).

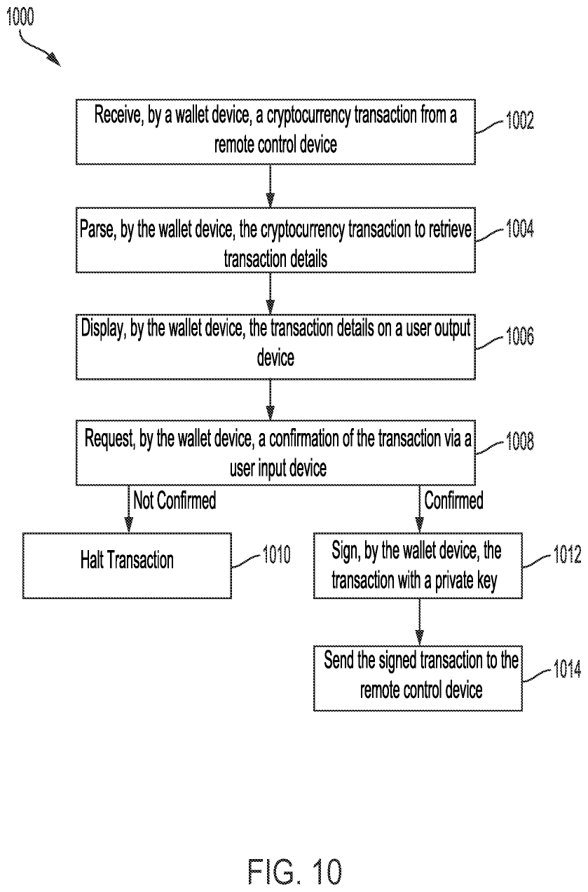

With reference to FIGS. 1A-B and FIG. 10, a method 1000 of transaction signature and approval by a crypto wallet is disclosed. The method may include, receiving, by a hardware wallet device 4, a cryptocurrency transaction from a remote control device 6 (block 1002). The method may include parsing, by the hardware wallet device 4, the cryptocurrency transaction to retrieve transaction details (block 1004). The method may include displaying, by the hardware wallet device 4, the transaction details on a user output component 16 (block 1006). The method may include requesting, by the hardware wallet device 4, confirmation of the transaction via a user input component 14 (block 1008). In response to the transaction not being confirmed, the transaction is halted (block 1010). In response to the transaction being confirmed, the transaction is signed by the hardware wallet device 4, with a private key stored in the digital storage unit 12 (block 1012). The signed transaction is sent by the hardware wallet device 4 to the remote control device 6 (block 1014).

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method of recovering electronic access to a cryptocurrency wallet on a hardware wallet device, the method comprising:
connecting, the hardware wallet device, to a physically attached removable authentication device in electronic communication with the hardware wallet device;
receiving, by a user input component of the hardware wallet device, a personal identification number (PIN) sequence;
comparing, by the removable authentication device, the PIN sequence to a stored PIN stored on the removable authentication device;
retrieving, by the hardware wallet device, in response to the stored PIN and the PIN sequence matching, a secret share from the removable authentication device and storing the secret share on the hardware wallet device;
determining if a number of stored secret shares on the hardware wallet device meets or exceeds a first threshold;
applying a first secrets sharing technique to the stored secret shares on the hardware wallet device to recover a seed value of the hardware wallet device and storing the recovered seed value on the hardware wallet device in response to the number of stored secret shares on the hardware wallet device meeting or exceeding the first threshold; and
displaying a message on a user output component of the hardware wallet device instructing a user to physically attach one or more additional removable authentication device to the hardware wallet device in electronic communication with the hardware wallet device in response to the number of stored secret shares on the hardware wallet device not meeting and not exceeding the first threshold.

2. The method of claim 1, wherein, following the displaying the message on the user output component of the authentication device, the method further comprises:
connecting, the hardware wallet device to the one or more additional removable authentication device in electronic communication with the hardware wallet device.

3. The method of claim 2, wherein the one or more additional removable authentication devices are connected sequentially or in series.

4. The method of claim 1, wherein the stored PIN stored on the removable authentication device is not revealed to the hardware wallet device.

5. The method of claim 2, further comprising:
receiving, by the user input component of the hardware wallet device, a further personal identification number (PIN) sequence;
comparing, by the one or more additional removable authentication devices, the further PIN sequence to a further stored PIN on the one or more additional removable authentication devices;
retrieving, by the hardware wallet device, in response to the further stored PIN matching the further PIN sequence, a further secret share from the removable authentication device and storing the further secret share on the hardware wallet device;
determining that the number of stored secret shares on the hardware wallet device meets or exceeds the first threshold; and
applying the first secrets sharing technique to the stored secret shares on the hardware wallet device to recover the seed value of the hardware wallet device and storing the recovered seed value on the hardware wallet device in response to the number of stored secret shares on the hardware wallet device meeting or exceeding the first threshold.

6. The method according to claim 5, wherein the first secrets sharing technique comprises Shamir's secret sharing method.

7. The method according to claim 1, further comprising:
notifying, by the hardware wallet device, a trusted server of a seed value restoration attempt;
transmitting, by the trusted server, a rejection message to a user electronic messaging platform;
receiving, by the trusted server, a denial message from the user electronic messaging platform;
providing, by the trusted server, the denial message to the hardware wallet device; and
interrupting, by the hardware wallet device, the method and denying recovery of the seed value in response to the receiving the denial message.

8. A method of establishing electronic access recovery credentials for a cryptocurrency wallet on a hardware wallet device, the method comprising:
setting, on the hardware wallet device, a first number, N, of secret shares to be generated based on a seed value;
setting, on the hardware wallet device, a second number, M, less than or equal to N, of secret shares required to recover a seed value;
applying, by the hardware wallet device, a first secret sharing technique to generate the first number, N, of the secret shares from the seed value;
communicating, by the hardware wallet device, with an attached removable authentication device;
receiving, from a user input component of the hardware wallet device, a PIN sequence;
setting, by the hardware wallet device, a PIN stored on the removable authentication device to be the PIN sequence;
storing, by the hardware wallet device, a first secret share of the first number, N, of secret shares of the hardware wallet device on the remote authentication device having the PIN sequence; and
displaying a message on a user output component of the hardware wallet device instructing a user to physically attach one or more additional removable authentication device to the hardware wallet device in electronic communication with the hardware wallet device.

9. The method of claim 8, wherein, following the displaying the message on the user output component of the authentication device, the method further comprises:
connecting, the hardware wallet device to the one or more additional removable authentication device in electronic communication with the hardware wallet device.

10. The method of claim 9, wherein the one or more additional removable authentication devices are connected sequentially or in series.

11. The method of claim 9, wherein the one or more additional removable authentication devices are connected in parallel.

12. The method of claim 9, further comprising:
communicating, by the hardware wallet device, with a further attached removable authentication device of the one or more additional removable authentication devices;
receiving, from the user input component of the hardware wallet device, a further PIN sequence;
setting, by the hardware wallet device, a further PIN stored on the further removable authentication device to be the further PIN sequence; and
storing, by the hardware wallet device, a further secret share of the first number, N, of secret shares of the hardware wallet device on the further remote authentication device having the further pin sequence.

13. The method of claim 9, wherein the first secret sharing technique is Shamir's secret sharing method.

14. A hardware wallet device to provide an electronically accessible cryptocurrency wallet, comprising:
a user input component configured to receive a personal identification number (PIN) sequence from a user;
a removable authentication device reader configured to physically attach to a physically attachable removable authentication device containing a stored PIN and connect the removable authentication device in electrical communication to a processor;
the processor, wherein the processor is configured to communicate with the removable authentication device to cause the removable authentication device to compare the PIN sequence to the stored PIN, wherein the processor is further configured to retrieve a secret share from the removable authentication device in response to the PIN sequence matching the stored PIN;
a digital storage unit configured to store the secret share retrieved from the removable authentication device,
wherein the processor is further configured to:
determine if a number of stored secret shares on the hardware wallet device meets or exceeds a first threshold; and
(i) in response to the number of stored secret shares on the digital storage unit of the hardware wallet device meeting or exceeding the first threshold, applying a first secrets sharing technique to the stored secret shares on the digital storage unit to recover a seed value of the hardware wallet device and storing the recovered seed value on the digital storage unit; and
(ii) in response to the number of stored secret shares on the digital storage unit not meeting and not exceeding the first threshold, displaying a message on a user output component of the hardware wallet device instructing a user to physically attach one or more additional removable authentication device to the hardware wallet device and in electronic communication with the hardware wallet device.

15. The hardware wallet device of claim 14, wherein, following the displaying the message on the user output component of the authentication device, the one or more additional removable authentication device connects in electronic communication with the hardware wallet device.

16. The hardware wallet device of claim 15, wherein the one or more additional removable authentication devices are connected sequentially or in series.

17. The hardware wallet device of claim 15, wherein the one or more additional removable authentication devices are connected in parallel.

18. The hardware wallet device of claim 15,
wherein the user input component is configured to receive a further personal identification number (PIN) sequence,
wherein the processor is configured to communicate with the one or more additional removable devices to cause the one or more additional removable devices to compare the further PIN sequence to a further stored PIN on the one or more additional removable authentication devices,
wherein the processor is configured to retrieve, in response to the further stored PIN matching the further PIN sequence, a further secret share from the removable authentication device and store the further secret share on the digital storage unit of the hardware wallet device,
wherein the processor determines that the number of stored secret shares on the digital storage unit of the hardware wallet device meets or exceeds the first threshold, and
wherein the processor applies, in response to the number of stored secret shares on the hardware wallet device meeting or exceeding the first threshold, the first secrets sharing technique to the stored secret shares on the digital storage unit to recover the seed value of the hardware wallet device and stores the recovered seed value on the digital storage unit.

19. The hardware wallet device according to claim 18, wherein the first secrets sharing technique comprises Shamir's secret sharing method.

20. The hardware wallet device according to claim 14,
wherein the hardware wallet device further comprises a communication device connected to the processor, wherein the communication devices is configured to notify a trusted server of a seed value restoration attempt,
wherein the trusted server is configured to transmit a rejection message to a user electronic messaging platform,
wherein the trusted server is configured to receive a denial message from the user electronic messaging platform,
wherein the trusted server is configured to provide the denial message to the hardware wallet device, and
wherein the processor of the hardware wallet device is configured to deny recovery of the seed value in response to the receiving the denial message.
